(19) United States
(12) Patent Application Publication
(10) Pub. No.: US 2012/0103762 A1
(43) Pub. Date: May 3, 2012

(54) CONVEYOR WITH PARALLEL CONVEYOR MEMBERS DEFINING A HELICAL PATH

(75) Inventor: Wouter Balk, Baambrugge (NL)

(73) Assignee: Ambaflex International BV, Zwaag (NL)

(21) Appl. No.: 13/320,093

(22) PCT Filed: May 11, 2010
(86) PCT No.: PCT/EP2010/056424

§ 371 Date: Jan. 5, 2012

(30) Foreign Application Priority Data
May 13, 2009 (NL) 2002878

(51) Int. Cl. B65G 15/12; B65G 23/28; B65G 21/18

(52) U.S. Cl. 198/817

(57) ABSTRACT

A conveyor for conveying products comprises at least two drivable endless conveyor members for supporting products. The conveyor members extend substantially parallel to each other as seen from above and define a helical path. The conveyor is arranged such that under operating conditions the conveyor members have substantially equal angular speeds.

### CROSS-REFERENCE TO RELATED APPLICATION

This application is a Section 371 National Stage Application of International Application PCT/EP2010/056424 filed May 11, 2010 and published as WO/2010/130716 in English.

### BACKGROUND

The discussion below is merely provided for general background information and is not intended to be used as an aid in determining the scope of the claimed subject matter.

An aspect of the invention relates to a conveyor for conveying products.

A conveyor defining a helical path is known in the art. The advantage of such a conveyor type is that it has a relatively long conveying path within a certain space. It also provides the opportunity to transport products over a height distance in a gradual way. Helical conveyors are often provided with laterally displaceable conveyor belts, such as slats mounted to a drivable chain which is laterally bendable. This means that such a conveyor belt is able to follow a curved path within its own plane. Such conveyor belts require a certain ratio between radius and belt width, for example the inner radius may be 1-2.5 times the belt width. A large belt width thus requires a relatively large radius. This can be minimized by applying parallel conveyor belts.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

In an exemplary first embodiment, a conveyor for conveying products includes a helical portion defining a helical path and a transfer portion defining a non-helical path into which the helical path transfers, and at least two drivable endless conveyor members for supporting products extending substantially parallel to each other as seen from above within the helical portion. The conveyor members are driven such that under operating conditions the conveyor members have substantially equal angular speeds within the helical portion. The non-helical path has a different radius with respect to the helical path, wherein in line with one of said conveyor members a drivable transfer conveyor member is provided at the transfer portion, whereas the other conveyor member extends substantially parallel thereto at the transfer portion as seen from above. The transfer conveyor member is driven such that also the angular speeds of the transfer conveyor member and the other conveyor member extending parallel thereto within the transfer portion are substantially equal.

In an exemplary second embodiment, a conveyor for conveying products includes a helical portion defining a helical path and a transfer portion defining a non-helical path into which the helical path transfers, and at least two drivable endless conveyor members for supporting products extending substantially parallel to each other as seen from above within the helical portion. The conveyor members are driven such that under operating conditions the conveyor members have substantially equal angular speeds within the helical portion. The non-helical path has a different radius with respect to the helical path, wherein in line with the conveyor members a drivable single transfer conveyor member is provided at the transfer portion.

The advantage of such a conveyor is that a product can be supported and conveyed by both conveyor members within the helical portion without frictional forces exerted on the product as a consequence of relative speed differences between both conveyor members. Furthermore, any change of orientation of the product on the conveyor members with respect to both conveyor members will be minimized or even eliminated. This reduces the risk of damage or clamping of the product in the conveyor. Preferably, supporting surfaces of the conveyor members are substantially flush as seen in lateral direction with respect to the conveying direction and free from obstacles in lateral direction for simply laying a product on both conveyor members. Since the angular speeds of the conveyor members are substantially equal, the absolute conveying speed of the conveyor member extending in an outer track of the helical path is higher than that of the conveyor member extending in an inner track of the helical path within the helical portion of the conveyor.

The first embodiment includes the feature that in line with one of the conveyor members, a drivable transfer conveyor member is provided at the transfer portion, whereas the other conveyor member extends substantially parallel thereto at the transfer portion as seen from above, and wherein the transfer conveyor member is driven such that also the angular speeds of the transfer conveyor member and the other conveyor member extending parallel thereto within the transfer portion are substantially equal. This means that the other conveyor member follows both the helical path within the helical portion and the non-helical path within the transfer portion. In practice, the non-helical path will have a larger radius than the helical path. If the conveyor members extended both along the helical path and the transfer portion, there would be a speed difference between the conveyor members within the transfer portion. This problem is solved by keeping the transfer portion as short as possible or by applying the mentioned feature.

In other words, one of the conveyor members in the helical path transfers into the transfer conveyor member in the transfer portion, whereas the other conveyor member continues in the transfer portion. As a consequence, the absolute speed of the continuing conveyor member is, of course, the same within the helical path and within the transfer portion, whereas the angular speed of the other conveyor member within the helical path and of the transfer conveyor member within the transfer portion can be adjusted independently from each other so as to equal the angular speeds of the continuing conveyor member within both the helical path and the transfer portion.

The second embodiment comprises the feature that in line with the conveyor members a drivable single transfer conveyor member is provided at the transfer portion. This means that a product supported by each of the conveyor members can be transferred to the single transfer conveyor member for conveying it further. Of course, the conveying direction may also be opposite. Preferably, the width of the single transfer conveyor member is larger than the width of one of the conveyor members, and in a specific embodiment the width substantially equals the sum of the widths of the conveyor members.

The single transfer conveyor member may be driven such that the absolute speed of the single transfer conveyor member lies between the absolute speeds of the conveyor members. This is a simple and low cost configuration whereas the mutual speed differences between each of the conveyor members and the single transfer conveyor are relatively small.

The transfer portion may define a substantially straight path. In this case the radius of the path of the transfer portion is infinite. This means that in case of applying the transfer conveyor member the angular speeds of the transfer conveyor member and the conveyor member extending parallel thereto are equal to their absolute speeds. The helical path may be extended by a short straight path as indicated above. An advantage of the straight path is that a rotatable reversing element or driving element of a conveyor member may have a cylindrical shape.

The conveyor may be arranged such, that at least one conveyor member is guided back along the helical path through a reversing element. Particularly, this provides the opportunity to obtain a gradual transfer between one of the conveyor members and the transfer conveyor member or the single transfer conveyor member. In an embodiment, the reversing element has a cylindrical shape, for example a cylindrical roller.

The conveyor members can be laterally displaceable. At least one of the conveyor members may comprise a drivable endless transport element and elements which are movable with respect to each other for supporting products thereon connected to the transport element. For example, the drivable endless transport element may comprise a chain, and the elements which are movable with respect to each other may comprise slats for supporting products thereon. These embodiments also allow applying a cylindrical reversing roller for guiding the conveyor member back along the helical path.

A cylindrical reversing element or reversing roller is advantageous compared to, for example, a conical reversing roller, since it allows a more gradual transfer to a next conveyor member. A gradual transfer provides the opportunity to transport articles in a stable manner, for example small and/or fragile products.

In practice the helical path may have a relatively short substantially straight end portion at which the reversing element is located in order to simplify the reversing element. For example, in case the reversing element comprises a sprocket which guides and/or drives a chain the length of the straight portion may be longer than the contact length between the sprocket and the chain as measured in a conveying direction. In this case the reversing element at the end portion may be cylindrical.

An aspect of the invention also relates to a conveyor for conveying products, comprising at least two drivable endless conveyor members for supporting products extending substantially parallel to each other as seen from above and defining a helical path, wherein each of the conveyor members comprises an endless driving device and slats for supporting products thereon connected to the endless driving device. The at least one conveyor member is guided back along the helical path through a reversing element. The advantage of this conveyor is that a relatively wide supporting surface is possible. The width of a helical conveyor member comprising slats extending in lateral direction with respect to the conveying direction depends on the radius of its helical path. A relatively small radius allows only a relatively narrow supporting surface since a large opening may arise between successive slats at the outer curve of the helical path. This is solved by the conveyor due to a parallel conveyor path. In practice the endless driving device comprises a chain which is driven by a sprocket. In one embodiment, the conveyor is arranged such that under operating conditions the conveyor members have substantially equal angular speeds within the helical path. The slats may be elongated elements extending in lateral direction with respect to the conveying direction.

The driving device may be drivable and/or guidable by a rotating member which is located at an end portion or an extended non-helical portion of the helical portion of the conveyor, preferably at a straight portion thereof, or at the transfer between the helical and the extended non-helical portion such that the non-helical portion can be as short as possible. This means that a cylindrical rotating member can be applied.

Preferably, the distance between the conveyor members is smaller than 5%, and preferably smaller than 1%, of the width of the narrowest conveyor member. This minimizes the risk that a product falls between the conveyor members. In practice, the conveyor members may be disposed close to each other such that they are just free from each other. Alternatively, the conveyor members may touch each other since they have substantially equal angular speeds which minimizes slip between both conveyor members.

Furthermore, the space directly above the conveyor members can be substantially free of obstacles as seen transversely with respect to the conveyor members, because this facilitates placing a single product on both conveyor members.

The conveyor member at the extended non-helical portion of the helical portion of the conveyor may have a different radius with respect to the conveyor member at the helical path, and the length of the conveyor member in the extended non-helical portion may be shorter than half of the radius of the helical path, and in one embodiment, at least larger than a contact area between the conveyor member and the reversing element as seen in a transport direction of the conveyor member. The reversing element may be located below an upper part of the conveyor member at the helical path and/or below an upper part of the conveyor member at the extended non-helical portion. The extended non-helical portion is preferably relatively short and substantially straight. A straight extended non-helical portion allows the application of a cylindrical reversing element and a relatively short extended non-helical portion provides the opportunity to locate a next conveyor close to the extended non-helical portion at substantially the same height level wherein the influence of the different angular speeds of the conveyor member at the extended non-helical portion and at the helical path on a transported article is minimized. The length of the conveyor member within the extended non-helical portion may be smaller than 25% or even smaller than 10% of the radius of the helical path. If the reversing element is only located at the helical path, the conveyor member does not have an extended non-helical portion including a radius which is different from the radius of the helical path.

### BRIEF DESCRIPTION OF THE DRAWINGS

Aspects of the invention will hereafter be elucidated with reference to the schematic drawings showing embodiments of the invention by way of example.

FIG. 1 is a perspective view of an embodiment of the conveyor.

FIG. 2 is a schematic plan view of an alternative embodiment of the conveyor.

FIG. 3 is a similar view as FIG. 2 of an alternative embodiment on a larger scale.

FIG. 4 is a schematic plan view of a part of an alternative embodiment of the conveyor, illustrating the driving device.

FIG. 5 is a partly cut-away view of the embodiment of FIG. 4.

FIG. 6 is a similar view as FIG. 5, but showing an alternative driving device.

### DETAILED DESCRIPTION OF THE ILLUSTRATIVE EMBODIMENTS

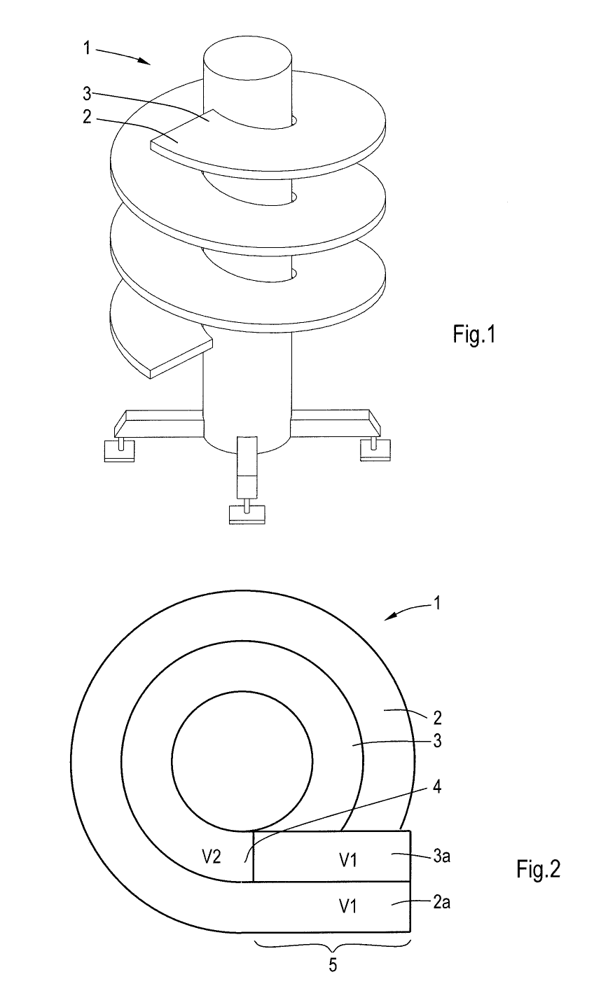

FIG. 1 shows a perspective view of an embodiment of a conveyor 1. The conveyor 1 has a helical shape and comprises an outer drivable endless conveyor member 2 and an inner drivable endless conveyor member 3 (both not shown in detail) extending parallel to each other. As seen from above the outer conveyor member 2 envelopes the inner conveyor member 3. The radius of the helical path of the conveyor 1 as measured from a center line of the helical path is substantially constant along the helical path. Each outer and inner conveyor member 2, 3 has its own driving device, and in this case, comprises a driven chain and slats connected thereto. The slats may be elongated elements extending in lateral direction with respect to the conveying direction and are positioned such that they serve as a supporting surface for carrying products. In practice the supporting surfaces of the outer and inner conveyor members 2, 3 may be flush. Alternative conveyor member configurations are conceivable. The outer and inner conveyor members 2, 3 are located closely to each other such that only a small gap is present between the outer and inner conveyor members 2, 3. This is, however, not essential. Under operating conditions a product is supported by both the outer and inner conveyor members 2, 3 in a conveying direction of the conveyor members 2, 3 along the helical path of the conveyor 1.

The outer and inner conveyor members 2, 3 are driven such that under operating conditions the conveyor members 2, 3 have substantially equal angular speeds. This means that the outer conveyor member 2 located at an outer curve side of the conveyor 1 has a higher absolute speed in the conveying direction than the inner conveyor member 3 located at an inner curve side of the conveyor 1. As a consequence of the equal angular speeds a single product supported by both conveyor members 2, 3 keeps its orientation with respect to both conveyor members 2, 3 during transport within the conveyor 1. Both conveyor members 2, 3 together behave like a single conveyor member in this case.

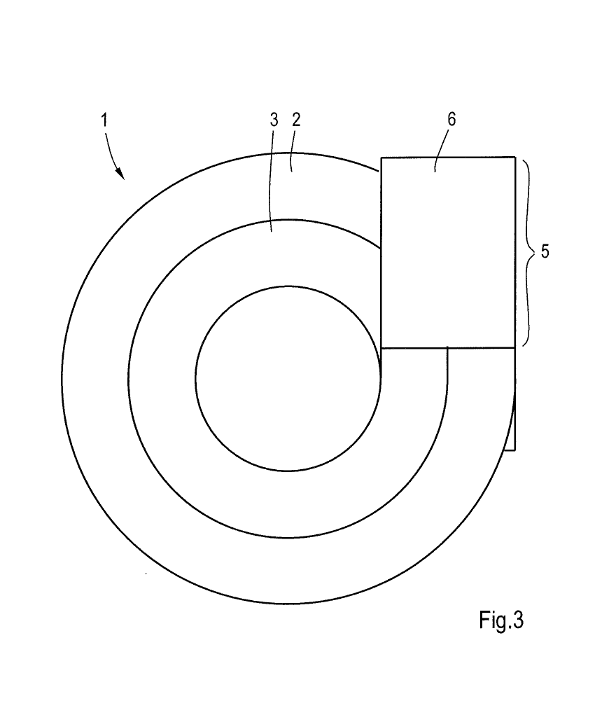

FIG. 2 shows an alternative embodiment of the conveyor 1. The outer conveyor member 2 is extended by a straight portion 2a, whereas the inner conveyor member 3 stops at an end portion 4 thereof. If the inner conveyor member 3 was also extended by a second straight portion extending parallel to the straight portion 2a, the absolute speed of the straight portion 2a would be higher than the second straight portion. As a consequence, a single product supported by the inner conveyor member 3 and the outer conveyor member 2 could be taken with the outer conveyor member 2 and slip with respect to the inner conveyor member 3 or in opposite way. This situation is avoided in the embodiment as shown in FIG. 2. In this embodiment the track followed by the inner conveyor member 3 is extended by a transfer conveyor member 3a located beyond the end portion 4 of the inner conveyor member 3 as seen along the corresponding track from the inner conveyor member 3. The transfer conveyor member 3a has its own driving device and is tangentially connected with the inner conveyor member 3 as seen from above. This does not mean that the inner conveyor 3 and the transfer conveyor member 3a must be mechanically connected to each other. In practice the transfer conveyor member 3a may also be an endless conveyor member and may be similar to the inner conveyor member 3. The transfer conveyor member 3a will be driven at a higher absolute speed than the inner conveyor member 3 such that it substantially equals the absolute speed of the outer conveyor member 2 at the straight portion 2a thereof.

In the embodiment as shown in FIG. 2, the conveyor 1 comprises a helical portion and a transfer portion 5. As seen from the helical portion the curved path thereof transfers into the transfer portion 5 which is straight in this case. Alternatively, the transfer portion 5 may also be curved having a different radius with respect to that of the helical path. In general, the transfer portion 5 defines a non-helical path.

In order to create an appropriate transfer of products between the inner conveyor member 3 and the transfer conveyor member 3a, the conveyor 1 is provided with a reversing roller at the end portion 4 of the endless conveyor member 3. More specifically, the endless conveyor member 3 may be described as having an upper part for supporting products thereon and a lower part which follows the same helical path below the upper part so as to guide the conveyor member 3 back. This configuration is easier in this case than a short circuit configuration such as in conventional helical conveyors in which the upper part after passing the reversing roller is guided directly to another turn level of the helical conveyor. The latter configuration could be applied more easily if the end portion 4 of the inner conveyor member 3 was located beyond an outer circumference of the helix of the conveyor 1. The transfer conveyor member 3a and the inner conveyor member 3 may be arranged such that their supporting surfaces at the transfer between both conveyor members 3, 3a are substantially flush.

The transfer between the transfer conveyor member 3a and the inner conveyor member 3 at the end 4 of the endless conveyor member 3 may also comprise a certain height difference. For example, the transfer conveyor member 3a may end slightly above the inner conveyor member 3 at the end portion 4 thereof. The inner conveyor member 3 may also partly continue, for example, below the transfer conveyor member 3a. The height difference can be minimized by minimizing the diameter of a reversing roller of the transfer conveyor member 3a at the end portion 4. In case a single product is supported by both the transfer conveyor 3a and the straight portion 2a of the conveyor member 2 the product will partly fall down onto the inner conveyor member 3 at the end portion 4 thereof when it is conveyed from the transfer portion 5 in the direction of the helical path.

In case products are transported in downward direction in the helical portion in the direction of the transfer portion 5 the situation is different, because the transfer conveyor member 3a is then located above the inner conveyor member 3 at the transfer between both conveyor members 3, 3a. This means that a single product must be lifted partly at the end portion 4.

FIG. 3 shows an alternative embodiment of the conveyor 1. This embodiment is provided with a drivable single transfer conveyor member 6 at the transfer portion 5. The single transfer conveyor member 6 is in line with both outer and inner conveyor members 2, 3 as seen from above. The single transfer conveyor member 6 can be driven such that its speed of conveying lies between the absolute speeds of the outer and inner conveyor members 2, 3.

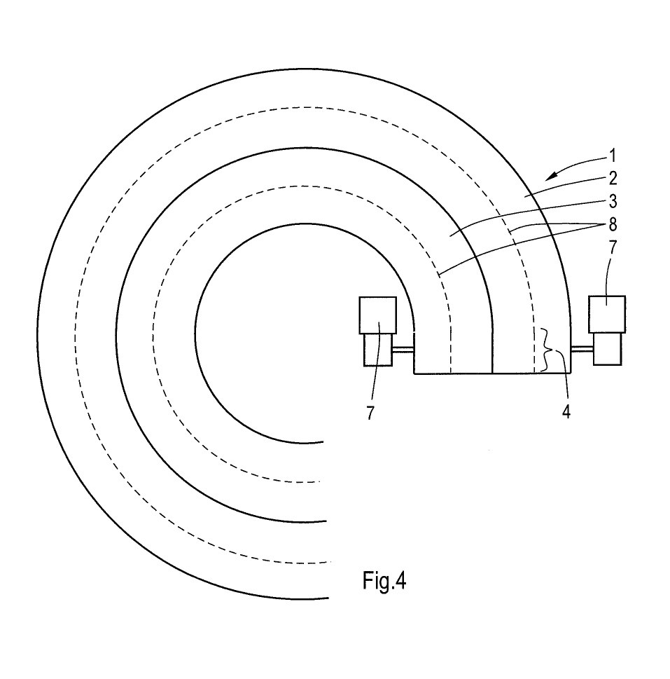

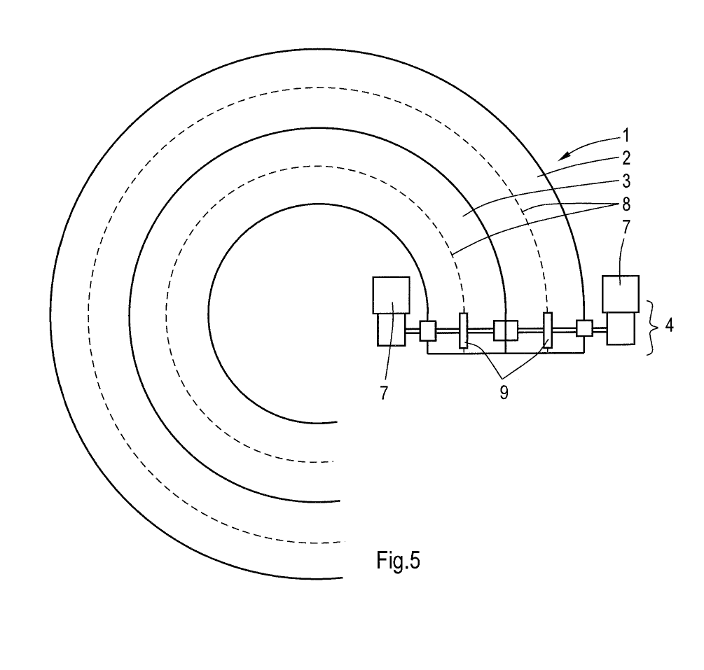

FIG. 4-6 illustrate a driving device of the outer and inner conveyor members 2, 3. The conveyor members 2, 3 are driven by separate electric motors 7, which drive chains 8 to which slats for supporting a product are attached. In this case the helical path has a relatively short extended non-helical portion or substantially straight end portion 4 at which rotating members or reversing elements 9 are located, see FIG. 5. The reversing elements are sprockets 9 which guide and drive the chains 8. The straight end portion 4 may be as short as the contact length between a sprocket 9 and the corresponding chain 8 as seen from above. This minimizes the effect of angular speed differences between the outer and inner conveyor member 2, 3 within the end portion 4, whereas the sprockets 9 can correctly mate with the corresponding chains 8.

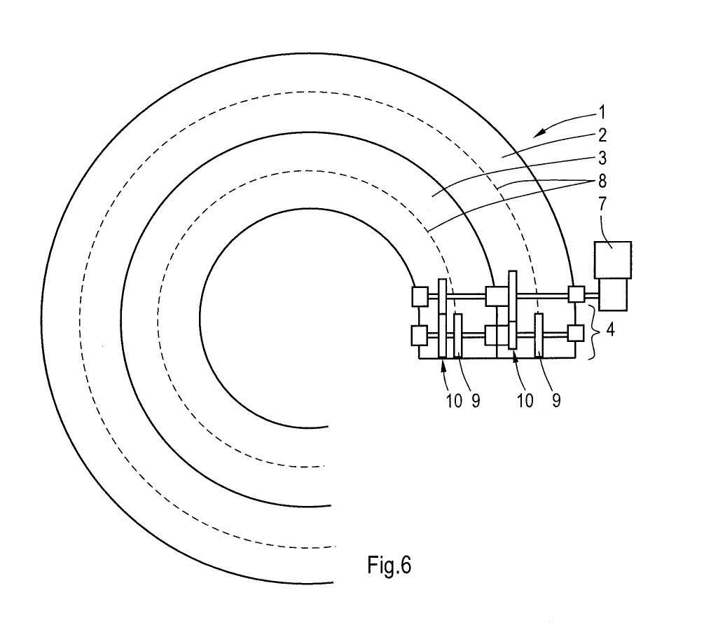

FIG. 6 shows an alternative embodiment in which a single electric motor drives both chains 8 via a transmission 10. The transmission 10 is configured such that the angular speeds of the outer conveyor member 2 and the inner conveyor member 3 are substantially the same within the helical path. Their speeds in the straight end portion 4 will be different, but the length of the end portion is relatively short.

From the foregoing, it will be clear that the invention provides a conveyor comprising parallel conveyor members which together support and convey a product through a curved path in a stable way.

The invention is not limited to the embodiments shown in the drawings and described hereinbefore, which may be varied in different manners within the scope of the claims and their technical equivalents. It is possible, for example, that the helical path is replaced by an alternative curved path having a fixed radius. Furthermore, a greater number than two parallel conveyor members may be applied. It is also possible that in line with the outer conveyor member also a second drivable transfer conveyor member is mounted parallel to the transfer conveyor member within the transfer portion instead of continuing the outer conveyor member into the transfer portion.

Aspects of the invention also include the following aspects:

Aspect 1: A conveyor for conveying products, comprising at least two drivable endless conveyor members for supporting products extending substantially parallel to each other as seen from above and defining a helical path, wherein the conveyor is arranged such that under operating conditions the conveyor members have substantially equal angular speeds.

Aspect 2: A conveyor according to aspect 1, wherein the conveyor is provided with a transfer portion into which the helical path transfers, the transfer portion having a different radius with respect to the helical path.

Aspect 3: A conveyor according to aspect 2, wherein in line with at least one of said conveyor members a drivable transfer conveyor member is provided at the transfer portion, and wherein the conveyor is arranged such that also the angular speeds of the transfer conveyor member and the conveyor member extending parallel thereto within the transfer portion are substantially equal.

Aspect 4: A conveyor according to aspect 2, wherein in line with the conveyor members a drivable single transfer conveyor member is provided at the transfer portion.

Aspect 5: A conveyor according to aspect 4, wherein the conveyor is arranged such that the absolute speed of the single transfer conveyor member lies between the absolute speeds of the conveyor members.

Aspect 6: A conveyor according to one of the aspects 2-5, wherein the transfer portion defines a substantially straight path.

Aspect 7: A conveyor according to one of the preceding aspects, wherein the conveyor is arranged such, that at least one conveyor member is guided back along the helical path through a reversing element.

Aspect 8: A conveyor according to aspect 7, wherein the reversing element has a cylindrical shape.

Aspect 9: A conveyor according to one of the preceding aspects, wherein the conveyor members are laterally displaceable.

Aspect 10: A conveyor according to one of the preceding aspects, wherein at least one of the conveyor members comprises a drivable endless transport element and elements which are movable with respect to each other for supporting products thereon connected to the transport element.

Aspect 11: A conveyor according to aspect 10, wherein the transport element comprises a chain and the movable elements for supporting products comprise slats.

Aspect 12: A conveyor for conveying products, comprising at least two drivable endless conveyor members for supporting products extending substantially parallel to each other as seen from above and defining a helical path, wherein each of the conveyor members comprises an endless driving means and slats for supporting products thereon connected to the endless driving means, and wherein at least one conveyor member is guided back along the helical path through a reversing element.

Aspect 13: A conveyor according to aspect 12, wherein the driving means are drivable and/or guidable by a rotating member which is located at a non-helical portion of the conveyor, preferably at a straight portion thereof.

Aspect 14: A conveyor according to one of the preceding aspects, wherein the distance between the conveyor members is smaller than 5%, and preferably smaller than 1%, of the width of the narrowest conveyor member.

Aspect 15: A conveyor according to one of the preceding aspects, wherein the space directly above the conveyor members is substantially free of obstacles as seen transversely with respect to the conveyor members.

Aspect 16: A conveyor according to aspect 7 or 12, wherein the reversing element is located at the helical path and/or at an end portion of the conveyor member into which the helical path transfers, wherein the conveyor member at the end portion has a different radius with respect to the conveyor member at the helical path, and wherein the length of the conveyor member in the end portion is shorter than half of the radius of the helical path, and preferably at least larger than a contact area between the conveyor member and the reversing element as seen in a transport direction of the conveyor member.

1. A conveyor for conveying products, comprising a helical portion defining a helical path and a transfer portion defining a non-helical path into which the helical path transfers, and at least two drivable endless conveyor members configured to support products and extending substantially parallel to each other as seen from above within the helical portion, wherein the conveyor members are driven such that under operating conditions the conveyor members have substantially equal angular speeds within the helical portion, the non-helical path having a different radius with respect to the helical path, wherein in line with one of said conveyor members a drivable transfer conveyor member is provided at the transfer portion, whereas the other conveyor member extends substantially parallel thereto at the transfer portion as seen from above and wherein the transfer conveyor member is driven such that also the angular speeds of the transfer conveyor member and the other conveyor member extending parallel thereto within the transfer portion are substantially equal.

2. A conveyor for conveying products, comprising a helical portion defining a helical path and a transfer portion defining a non-helical path into which the helical path transfers, and at least two drivable endless conveyor members configured to support products and extending substantially parallel to each other as seen from above within the helical portion, wherein the conveyor members are driven such that under operating conditions the conveyor members have substantially equal angular speeds within the helical portion, the non-helical path having a different radius with respect to the helical path, wherein in line with the conveyor members a drivable single transfer conveyor member is provided at the transfer portion.

3. The conveyor according to claim 2, wherein the single transfer conveyor member is driven such that the absolute speed of the single transfer conveyor member lies between the absolute speeds of the conveyor members

4. The conveyor according to claim 1, wherein the transfer portion defines a substantially straight path.

5. The conveyor according to claim 1, wherein the conveyor is arranged such, that at least one conveyor member is guided back along the helical path through a reversing element.

6. The conveyor according to claim 5, wherein the reversing element has a cylindrical shape.

7. The conveyor according to claim 1, wherein the conveyor members are laterally displaceable such that a curved path can be followed by the conveyor members.

8. The conveyor according to claim 1, wherein at least one of the conveyor members comprises a drivable endless transport element and elements which are movable with respect to each other and configured to support products thereon being connected to the transport element.

9. The conveyor according to claim 8, wherein the transport element comprises a chain and the elements comprise slats.

10. A conveyor for conveying products, comprising at least two drivable endless conveyor members configured to support products and extending substantially parallel to each other as seen from above and defining a helical path, wherein each of the conveyor members comprises an endless driving device and slats configured to support products thereon connected to the endless driving device, and wherein at least one conveyor member is guided back along the helical path through a reversing element.

11. The conveyor according to claim 10, wherein the driving devices are drivable and/or guidable by a rotating member which is located at an extended non-helical portion of the helical portion of the conveyor, preferably at a straight portion thereof.

12. The conveyor according to claim 1, wherein the distance between the conveyor members is smaller than 5% of the width of the narrowest conveyor member.

13. The conveyor (1) according to claim 1, wherein the space directly above the conveyor members is substantially free of obstacles as seen transversely with respect to the conveyor members.

14. The conveyor according to claim 11, wherein the path followed by the conveyor member at the extended non-helical portion of the helical portion of the conveyor has a different radius with respect to the path followed by the conveyor member at the helical path, and wherein the length of the conveyor member in the extended non-helical portion is shorter than half of the radius of the helical path.

15. The conveyor according to claim 11, wherein the path followed by the conveyor member at the extended non-helical portion of the helical portion of the conveyor has a different radius with respect to the path followed by the conveyor member at the helical path, and wherein the length of the conveyor member in the extended non-helical portion is shorter than half of the radius of the helical path and at least larger than a contact area between the conveyor member and the reversing element as seen in a transport direction of the conveyor member.

16. The conveyor according to claim 1, wherein the distance between the conveyor members is smaller than 1% of the width of the narrowest conveyor member.
